(19) United States
(12) Patent Application Publication
(10) Pub. No.: US 2010/0035083 A1
(43) Pub. Date: Feb. 11, 2010

(54) MIXTURE OF LOW PROFILE LUBRICANT AND CYCLOPHOSPHAZENE COMPOUND

(75) Inventors: Jiping Yang, San Jose, CA (US); Michael Joseph Stirniman, Fremont, CA (US); Xiaoding Ma, Fremont, CA (US); Jing Gui, Fremont, CA (US)

Correspondence Address: Shumaker & Sieffert, P.A., 1625 Radio Drive, Suite 300, Woodbury, MN, 55125, US

(73) Assignee: SEAGATE TECHNOLOGY LLC, Scotts Valley, CA (US)

(21) Appl. No.: 12/186,402

(22) Filed: Aug. 5, 2008

(51) Int. Cl. G11B 5/82; C10M 159/00

(52) U.S. Cl. 428/800; 508/548

(57) ABSTRACT

A composition comprising a mixture of a low profile lubricant and a compound comprising one or more cyclophosphazene rings. The low profile lubricant comprises a perfluoropolyether backbone, at least one functional group on each end of the backbone and at least one functional group located in a region of the backbone between the ends. Also a device comprising a magnetic disk and the composition on the magnetic disk.

### BACKGROUND

Recording densities in hard disk drives have been steadily increasing. Indeed, recording densities of 100 gigabits per square inch (Gbit/inch²) have been reported. A requirement for achieving these high densities is to reduce the distance between the magnetic head and the magnetic recording layer of the magnetic disk as much as possible. Currently, this distance is generally 20 nm.

To reduce this distance as much as possible, the surface roughness of the magnetic disk should be reduced as much as possible. Therefore, there has been a transition from the contact start/stop (CSS) systems to load/unload (L/UL) systems. In CSS systems, the magnetic head is in contact with the magnetic disk when the disk is not spinning and the magnetic head flies up due to air currents when the magnetic disk begins spinning. In L/UL systems, the magnetic head is retracted away from the magnetic disk (unloaded) when the disk is stopped and is loaded on to the magnetic disk when the magnetic disk begins spinning. Further, in L/UL systems, anti-sliding characteristics can be relaxed somewhat. The hard disk drive, however, must be able to withstand impacts from load-on operations as well as sudden irregularities in head orientation that can occur even in normal operations.

Traditionally, perfluoropolyether (PFPE) based lubricants have applied been on the top surface of the magnetic disk to reduce friction. However, PFPE based lubricants, such as Zdol and Ztetraol suffer from catalytic decomposition in the presence of Lewis acids, like Al₂O₃. It is believed that hydrogen fluoride (HF) is generated due to thermal decomposition from friction heat or decomposition, and that this HF causes a chain reaction that leads to further decomposition of the lubricating agent.

Additionally, long chain PFPE lubricants such as ZDol and ZTetraol have a further drawback. Because ZDol and ZTetraol only have functional groups (hydroxyl groups) on the two ends of perfluoropolyether (PFPE) chain, the chain tends to bulk up on the surface of the disk. The bulked up chain results in a lubricant with a high profile.

Improvements in the protective layer and lubricating layer on magnetic disks are being investigated to minimize frication and damage caused by contact between the head and the magnetic disk. For example, mixtures of lubricants that include a perfluoropolyether having a cyclophosphazene ring group have been reported. However, mixtures of a perfluoropolyether having a cyclophosphazene ring group with ZDol or ZTetraol lubricants still result in a high profile lubricant.

### SUMMARY

An embodiment of the present invention includes a composition comprising a mixture of a low profile lubricant and a compound comprising one or more cyclophosphazene rings, wherein the low profile lubricant comprises a backbone having a perfluoropolyether chain and at least three functional groups attached to the backbone.

Preferred embodiments of this invention are shown and described, simply by way of illustration of the best mode contemplated for carrying out this invention, in the following detailed description. As will be realized, this invention is capable of other and different embodiments, and its details are capable of modifications in various obvious respects, all without departing from this invention. Accordingly, the description is to be regarded as illustrative in nature and not as restrictive.

### BRIEF DESCRIPTION OF THE DRAWINGS

FIG. 1A is a schematic illustration of a media storage device.

FIG. 1B is a schematic illustration of a high profile lubricant.

FIG. 1C is a schematic illustration of a perfluoropolyether backbone.

FIG. 1D is a schematic illustration of the end group of a ZDol storage media lubricant.

FIG. 1E is a schematic illustration of the end group of a ZTetraol storage media lubricant.

FIG. 2 is a schematic illustration comparing a low profile lubricant with a high profile lubricant.

FIG. 3 illustrates an embodiment of a method of making a low profile lubricant of an embodiment of the invention.

FIG. 4 is an NMR plot of a low profile lubricant.

FIG. 5 is gas phase chromatography plot comparing a low profile lubricant with a high profile lubricant.

FIG. 6 is gas phase chromatography plot illustrating the synthesis of low profile lubricants of varying molecular weights.

FIG. 7 is an NMR plot of a low profile lubricant.

FIG. 8 is a box plot comparing altitude drag test results on different lube systems.

FIG. 9 is an NMR plot of a low profile lubricant.

FIG. 10 is a bar graph comparing the bond ratio of several low profile lubricants.

FIG. 11 is a bar graph comparing the lube loss of several embodiments of the invention.

FIG. 12 is a bar graph comparing the water contact angle of several embodiments of the invention.

FIG. 13 is a bar graph comparing the bond ratio of several embodiments of the invention.

FIG. 14 is a bar graph comparing the lube loss of several embodiments of the invention.

FIG. 15 is a bar graph comparing the water contact angle of several embodiments of the invention.

FIG. 16 is a plot illustrating the thermal stability of several low profile lubricants.

FIG. 17 is a plot illustrating the thermal stability of several low profile lubricants.

FIG. 18 is a plot illustrating the lube profile of several low profile lubricants.

FIG. 19 is a plot illustrating the diffusivity of several low profile lubricants.

FIG. 20 is a box plot illustrating the clearance comparison of several low profile lubricants with high profile lubricants.

FIG. 21 is a box plot illustrating a clearance comparison of several low profile lubricants with high profile lubricants.

FIG. 22 is a schematic illustration comparing the disc head avalanche height of an embodiment of the present invention with high profile lubricants.

FIG. 23 is a bar graph comparing stiction/friction performance of several low profile lubricants with high profile lubricants.

### DETAILED DESCRIPTION

Low profile lubricants are a new type of hard disk drive lubricant that allow the read/write head to fly lower on (or closer to) the media surface. This is because the low profile lubricant lies down more flatly on media surface. That is, the roughness of low profile lubricants is lower than traditional ZDol or ZTetraol lubricants.

Traditional lubricants such as ZDol or ZTetraol only have anchoring hydroxyl groups (functional groups) on the two ends of the PFPE chain. When these hydroxyl groups anchor to the carbon overcoat, the long, flexible polymer chain often bulk up. The result is a lubricant with a high profile that tends to increase the surface roughness. Many of the low profile lubricants of the present invention also have functional groups on the two ends of the PFPE chain. In addition, however, they also have one or more functional groups in the middle of the PFPE chain. In one embodiment of the invention, for example, the functional group is a hydroxyl group. Preferably, the middle functional group(s) bonds to the carbon overcoat. When such bonding occurs, the polymer adjacent the functional group is dragged down to the carbon overcoat surface. The result is a lubricant that lies down more flatly on the surface of the media. That is, a low profile lubricant.

The basic structure of the low profile lubricants used in the present invention, however, is similar to Zdol and Ztetraol type PFPE lubricants. Because of this, low profile lubricants suffer from so of the same shortcomings. That is, the low profile lubricants incorporated in the mixtures of the present invention suffer catalytic decomposition in the presence of Lewis acids. Thus, the durability of low profile lubricants is similar to that of Zdol and Ztetraol.

Compounds with cyclophosphazene rings tend to be more resistant to catalytic decomposition due to Lewis acids and thus more durable. That is, cyclophosphazene rings provide chemical stability to the lubricant mixture. The inventors have discovered that it is possible to formulate lubricant compositions having a low profile and improved durability by mixing low profile lubricants and compounds with cyclophosphazene rings. In one embodiment of the invention the ratio of low profile lubricant to cyclophosphazene compound is 1:1. In alternative embodiments of the invention, the ratio may vary from 10:1 to 1:10. Preferably, the ratio varies from 1:3 to 3:1.

### EXAMPLES

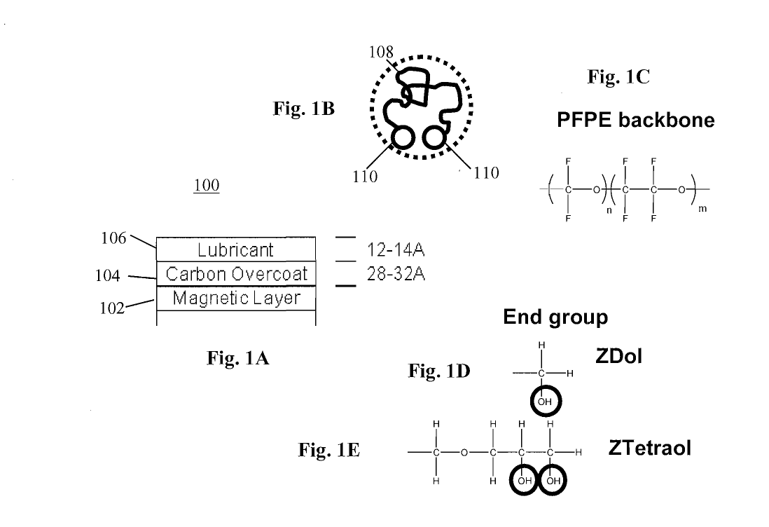

FIG. 1A illustrates a media storage device 100. The media storage device 100 includes a magnetic layer 102, a carbon overcoat 104, and a high profile lubricant 106. The carbon overcoat 104 is a hard coating that protects the magnetic layer 102. The lubricant 106 facilitates passage of the read/write head (not shown) over the media storage device 100.

FIG. 1B is a schematic illustration of a high profile lubricant 106. The high profile lubricant 106 has a PFPE backbone 108 with functional groups 110 at either end of the backbone 108. The functional groups 110 bond with the carbon overcoat 104, anchoring the high profile lubricant 106 to the surface of the media storage device 100. Because the backbone 108 is relatively long and is only anchored at two locations, the high profile lubricant 106 can bunch up on the surface. This is illustrated by the large dashed circle circumscribing the high profile lubricant molecule 106.

FIG. 1C illustrates the backbone 108 of a high profile PFPE. The end functional groups 110 of two high profile storage media lubricants 106 are illustrated in FIGS. 1D and 1E. FIG. 1D illustrates of the end functional group 110 of high profile storage media lubricant 106 ZDol, while FIG. 1E illustrates of the end functional group of high profile storage media lubricant 106 ZTetraol. ZDol has a single hydroxyl group at both ends of the PFPE backbone 108 while ZTetraol has two hydroxyl groups at the ends of the PFPE backbone 108.

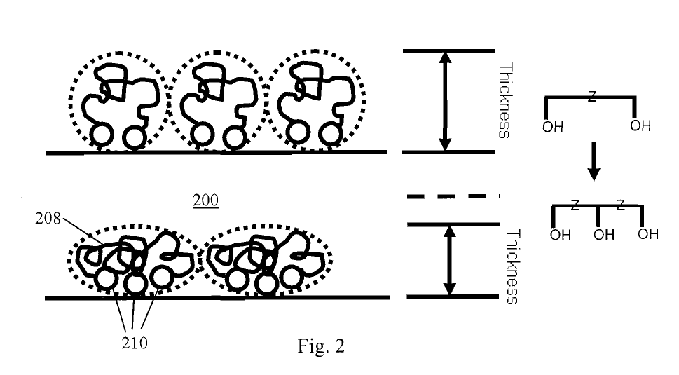

FIG. 2 is a schematic illustration comparing a low profile lubricant 200 of the present invention with a high profile storage media lubricant 106. In this embodiment, the low profile lubricant has three functional groups 210. Two of the functional groups 210 are at the ends of a PFPE backbone 208 similarly to the high profile lubricant 106. The low profile lubricant of the present embodiment, however, includes a third function group 210 in a region of the PFPE backbone 208 between the two ends. Preferably, in this embodiment the third functional group 210 is attached near the center of the PFPE backbone 208. However, the third functional group 210 need not be in the exact center.

In alternative embodiments of the invention, the low profile lubricant 200 includes a plurality of functional groups 210 attached in the region of the PFPE backbone 208 between the two ends. Indeed, Table I provides the molecular weight and number of functional groups for several low profile lubricants 200 fabricated and evaluated by the present inventors. All six of the low profile lubricants 200 in Table I were prepared by modifying a high profile ZDol 1000 lubricant. The number of functional groups in the PFPE backbone 208 in Table I range from 3 to 8. However, the number of functional groups are not limited to 8. Preferably, the additional functional groups 208 could be spaced relatively equally along the backbone 208. However, it is not necessary that the spacing be equal. Additionally, the molecular weight of the low profile lubricants are preferably between 1000 and 30,000 Daltons.

TABLE I

| | Starting | Mw | # of —OH Per |
|---|---|---|---|
| Lubricant | Material | (NMR) | Molecule |
| LPL-001A | Zdol 1000 | 3700 | 4 |
| LPL-002B | Zdol 1000 | 1800 | 3 |
| LPL-002C | Zdol 1000 | 4100 | 5 |
| LPL-003B | Zdol 1000 | 3100 | 4 |
| LPL-003C | Zdol 1000 | 6900 | 8 |
| LPL-004C | Zdol 2000 | 12000 | 7 |

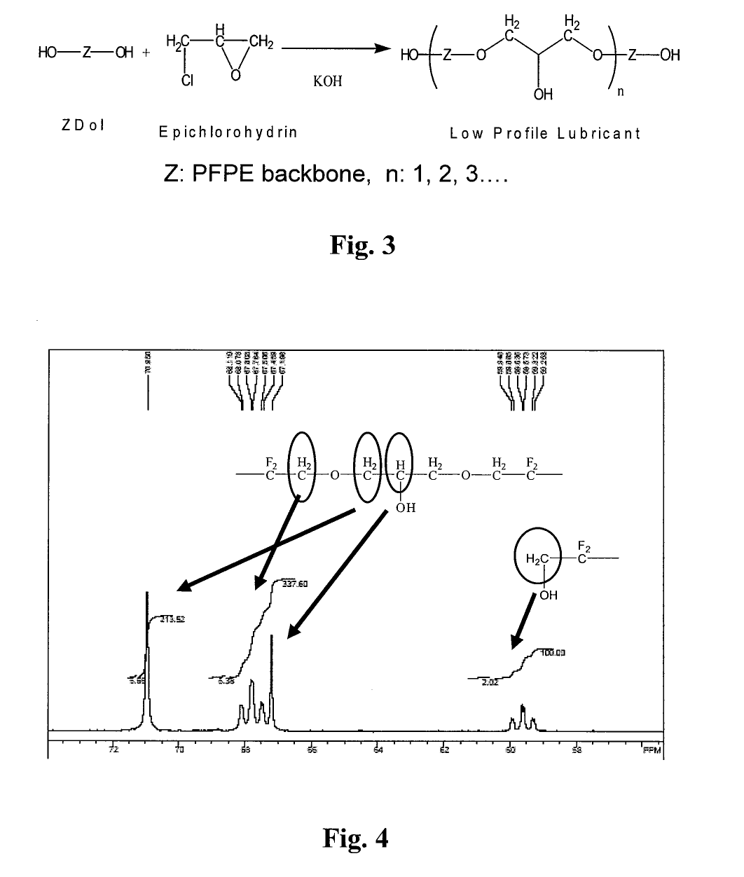

FIG. 3 illustrates one method of fabricating a low profile lubricant of the present invention. In this embodiment, a high profile ZDol lubricant is reacted with epichlorohydrin in the presence of KOH. The result is the addition of a hydroxyl group to the PFPE backbone of the ZDol molecule. The molecular weight of the resulting polymer can be controlled by, for example but not limited to, the molecular weight of the starting material, the mole ratio of Zdol to epichlorohydrin, and the reaction temperature. FIG. 4 is a 13C NMR plot of a low profile lubricant of a mixture according to one embodiment of the invention. This plot confirms that the molecular structure of the lubricant sample is what was predicted to be synthesized. In other words, it confirms the successful synthesis of the designed molecule.

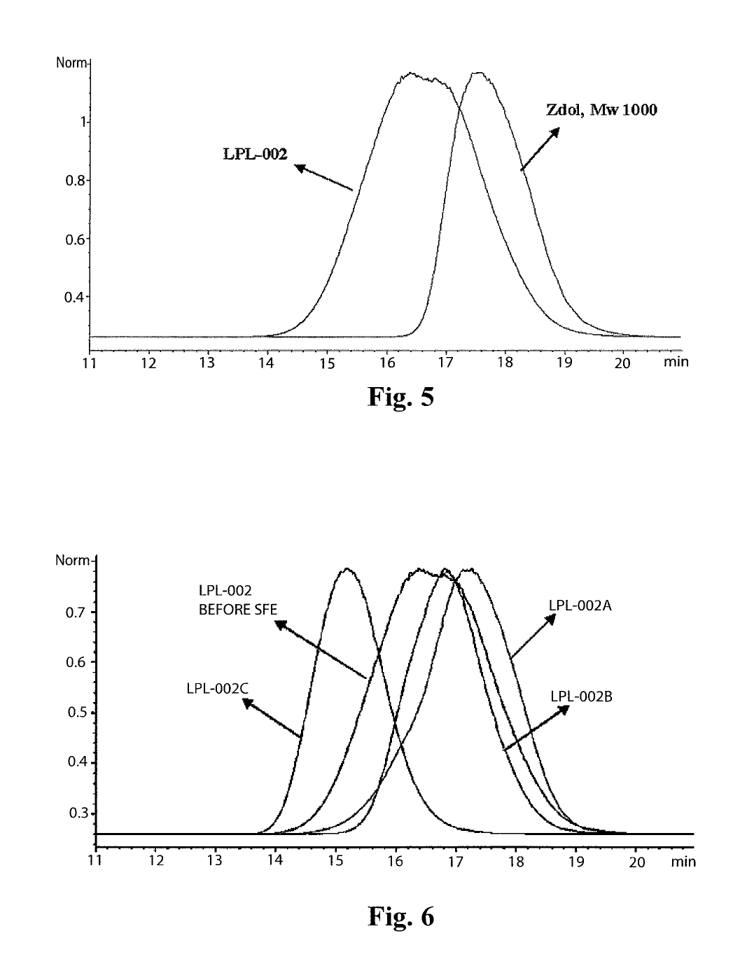

FIGS. 5 and 6 are chromatograms of gel permeation chromatography (GPC) comparing the molecular weight distribution of the synthesized low profile lubricant material to that of the starting material (Zdol1000). The figures further confirm that the synthesized low profile lubricants have higher molecular weights than ZDol1000 and provide further evidence of successful synthesis of the designed molecule. FIG. 6 further illustrates that the low profile lubricant material obtained through the synthesis route can be further fractionated into several fractions of different molecular weight. The GPC show that different fractions have different molecular weight distributions which provide choices for different applications.

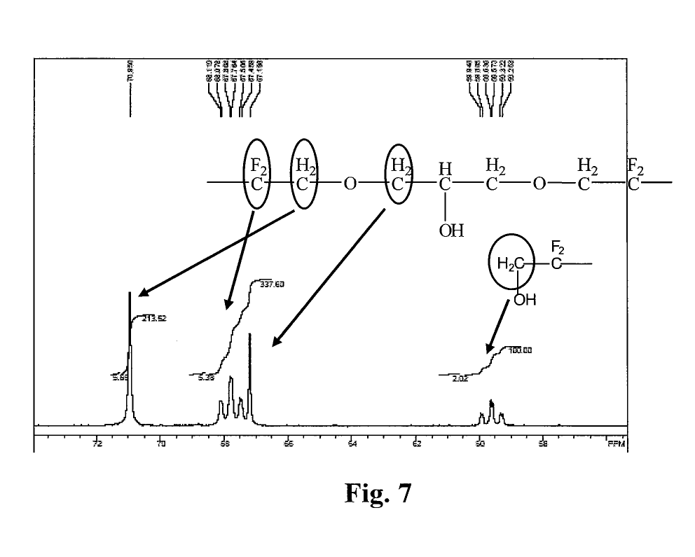

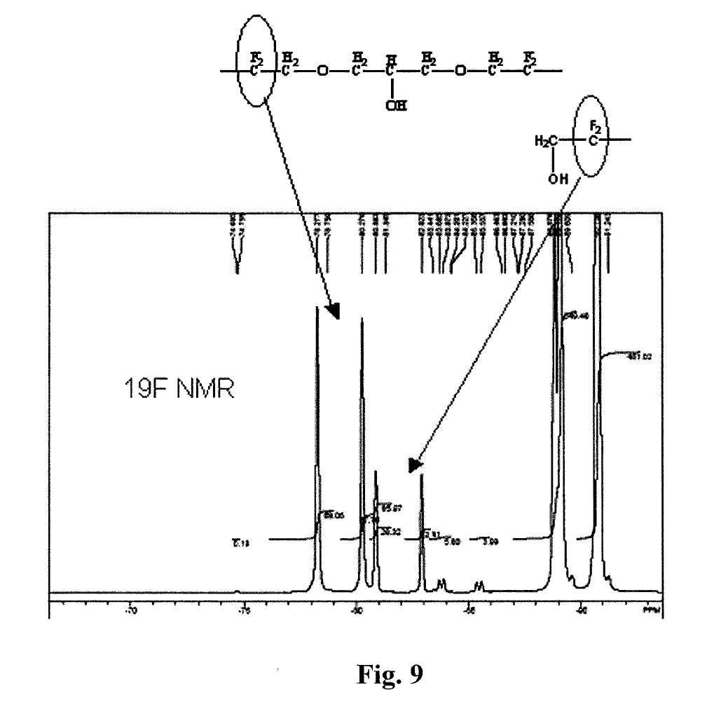

FIG. 7 is a 13C NMR plot of low profile lubricant 002C while FIG. 9 is a 19F NMR plot of low profile lubricant LPL-002C. These two NMR spectra together to confirm that LPL-002C has the desired molecular structure. These plots confirm that the synthesized materials are all low profile lubricant materials, differing only in their respective molecular weights.

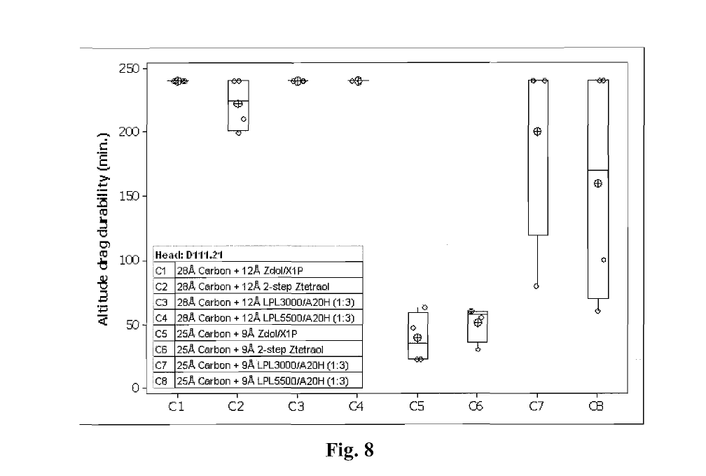

FIG. 8 is a box plot comparing several low profile lubricants of embodiments of the invention with high profile lubricants. Specifically, FIG. 8 illustrates the results of altitude drag durability testing of the various lubricants. The Altitude drag test is an accelerated wear test to evaluate disc durability under a head-disc contact condition. It is performed on a spin-stand where a recording head is brought to contact with a disc under a subambient pressure condition (simulating a high-altitude condition) while disc is spinning at a given rpm. The test was truncated at 240 minutes. The tests show that at 28 Å carbon/12 Å lubricant, mixtures including ZDol/X1P (C1), low profile lubricant 3B/A20H (C2), and low profile lubricant 3C/A20H (C4) passed 240 minutes. Ztetraol passed 200 minutes. At 25 Å carbon/9 Å lubricant, all of the lubricants failed to pass 240 minutes. ZDol/X1P (C5) and Ztetraol (C6) performed particularly poorly. However, low profile lubricant 3000/A20H (C7) and low profile lubricant 3C/A20H (C8) showed significantly greater durability than ZDol/X1P (C5) and Ztetraol (C6).

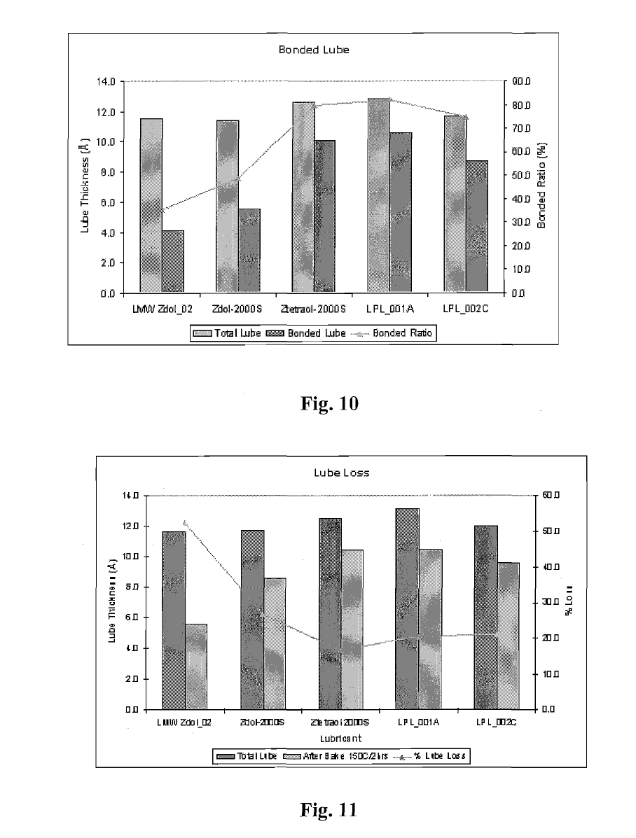

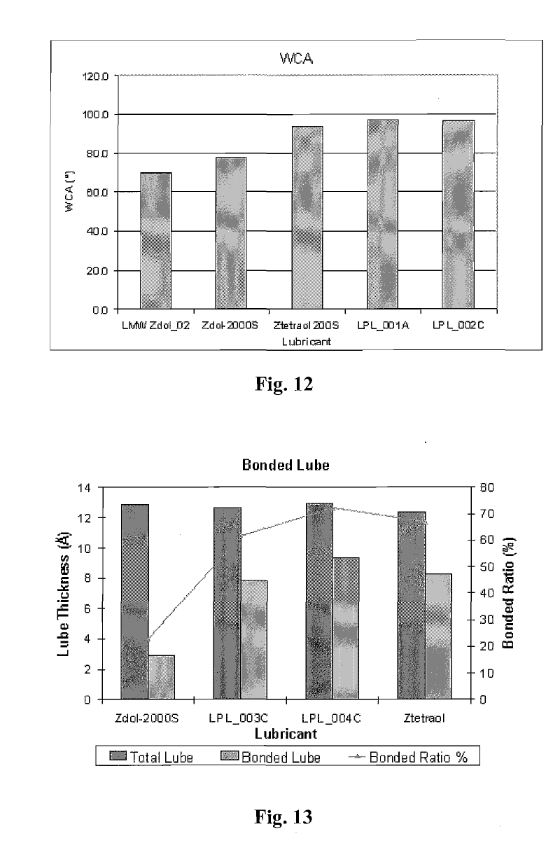

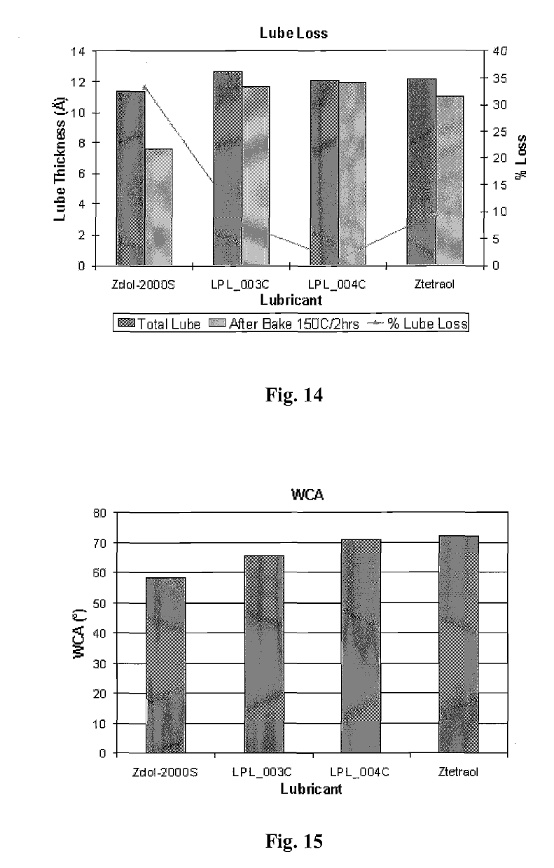

FIGS. 10-15 compare the bonded ratio, lube loss and water contact angle of various low profile lubricants with high profile lubricants. In general, the low profile lubricants, with their additional function groups, show a higher bonded ratio. However, Ztetraol, with four hydroxyl groups (two on either ends), also shows a high bonded ratio. On the other hand, the more functional groups in the low profile lubricant, the better it performed. Regarding lube loss, the low profile lubricants show a significantly lower lube loss than ZDol. Ztetraol performed better than ZDol. Again, the more functional groups in the low profile lubricant, the better it performed. Water contact angle, like bonded ratio and lube loss, correlates with the number of additional functional groups. The low profile lubricants all had superior water contact angles to ZDol and equivalent or superior water contact angles to ZTetraol.

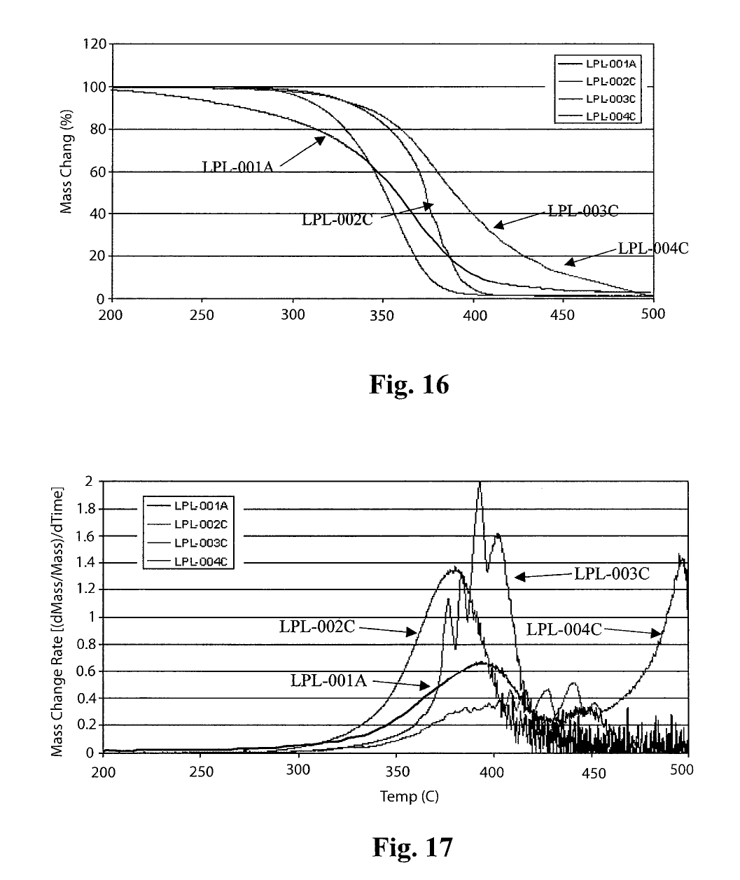

FIGS. 16 and 17 illustrate the thermal stability of the low profile lubricants. FIG. 16 is a plot of the mass change as a function of temperature while FIG. 17 is a plot of the mass change rate as function of temperature. These figures illustrate that the thermal stability generally increases as the number of functional groups increases and the molecular weight increases.

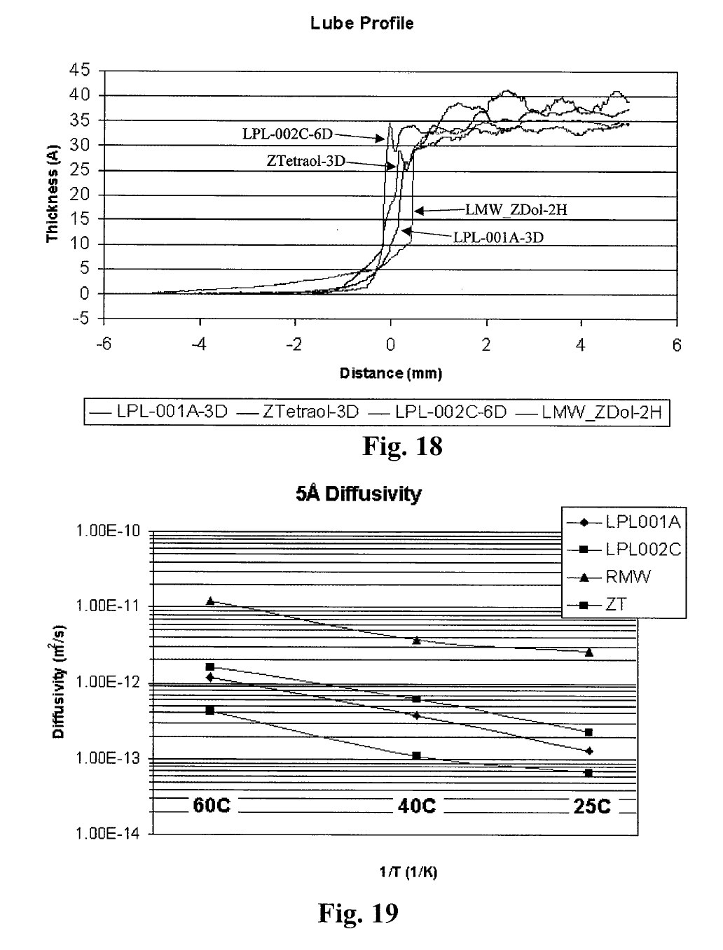

FIG. 18 illustrates the lube profile of several low profile lubricants. Table II summarizes a comparison of the molecular weight and monolayer thickness of several low profile lubricants, a low molecular weight ZDol and Ztetraol. This table illustrates that even thought the low profile lubricants have a high molecular weight, they have a thinner monolayer thickness. Preferably, the lubricant mixtures of the various embodiments of the invention have a thickness of approximately 3 to 25 Å. More preferably, the thickness is between 9 and 15 Å.

TABLE II

| | | | Monolayer |
|---|---|---|---|
| Lubricant | Mw | OH | Thickness (A) |
| LMW_Zdol | 1000 | 2 | 9 |
| Ztetraol | 2000 | 4 | 20 |
| LPL-001A | 3700 | 4 | 12 |
| LPL-002C | 4100 | 5 | 9 |

FIG. 19 compares the diffusivity of two low profile lubricants with RMW (a fractionated Zdol lubricant with a narrower molecular weight distribution than commercial Zdol) and ZTetraol as a function of temperature. The two low profile lubricants exhibit a higher diffusivity than ZTetraol but lower than RMW.

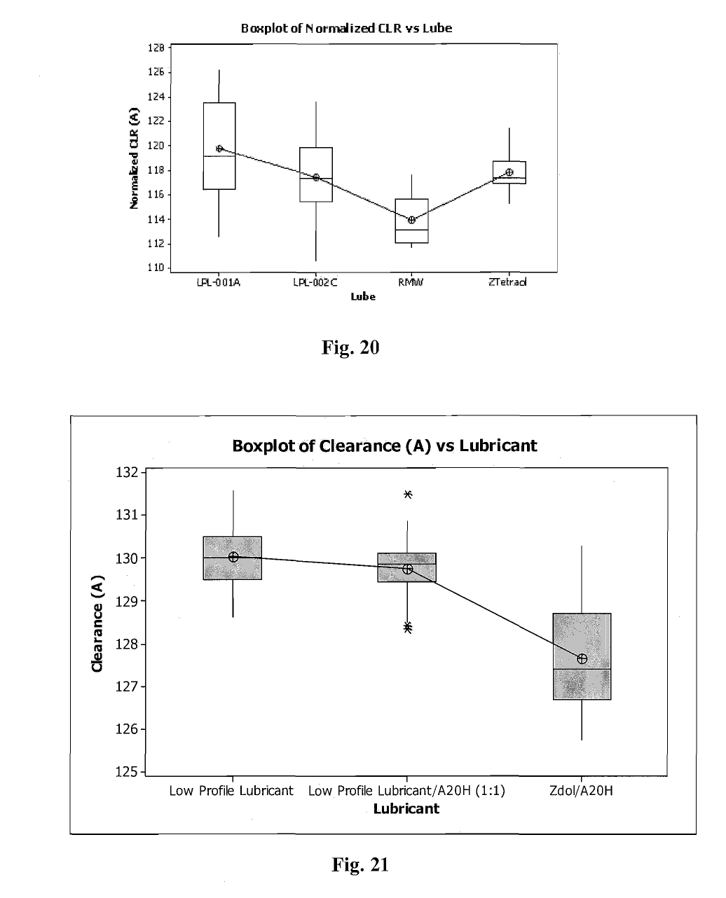

FIGS. 20 and 21 are box plots comparing the clearance of various low profile lubricants with high profile lubricants. FIG. 21 compares a single low profile lubricant with a mixture of a low profile lubricant with A20H (1:1) and a mixture of high profile ZDol with A20H. The two low profile lubricants and ZTetraol exhibit significantly better clearance than RMW. LPL-001A exhibits higher clearance than ZTetraol, although the difference is less than the difference over RMW.

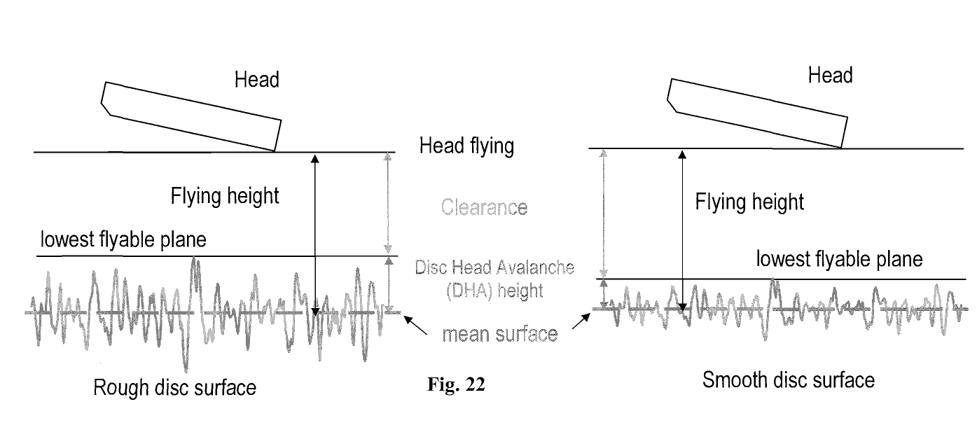

FIG. 22 is a schematic illustration comparing the disc head avalanche height and the clearance of a disc having a rough surface, i.e. one using a high profile lubricant, and a disc with a smooth surface, i.e. one using a low profile lubricant. The flying height of a media storage device is defined as the distance from the bottom of a flying read/write head to a theoretical line representing the mean surface of the disc. The clearance is the distance from the bottom of the flying read/write head to the highest peak on the actual surface of the disc. The difference between the two is the disc avalanche height. The disc head avalanche height is a measure of the amount of distance that is unavailable for a varying flying head to travel without hitting the surface. Conversely, the clearance is the amount of distance a varying flying head can travel without hitting the surface. A disc with a smooth surface has a smaller disc head avalanche height which translates into a larger clearance for a given flying height.

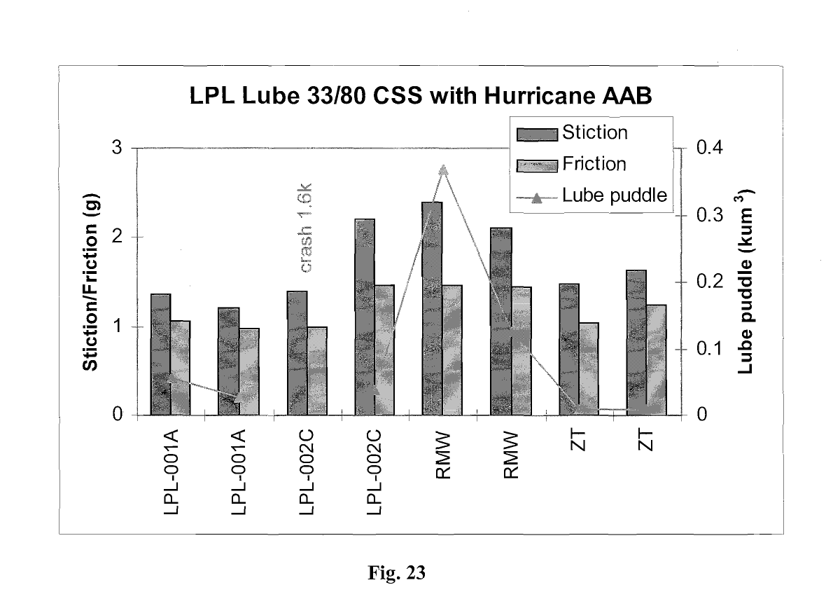

FIG. 23 is a bar chart comparing the stiction and friction properties of various low profile lubricants with RMW and ZTetraol. The low profile lubricants generally show lower stiction and friction properties than high profile lubricants.

The implementations described above and other implementations are within the scope of the following claims.

1. A composition comprising:
a mixture of a low profile lubricant and a compound comprising one or more cyclophosphazene rings, wherein the low profile lubricant comprises a backbone having a perfluoropolyether chain and at least three functional groups attached to the backbone.

2. The composition of claim 1, wherein the low profile lubricant comprises at least one functional group on each end of the backbone and a plurality of functional groups located in a region between the ends of the backbone.

3. The composition of claim 1, wherein the functional groups comprises hydroxyl groups or diols.

4. The composition of claim 1, wherein the one or more cyclophosphazene rings comprise alkoxy, aryloxy substituents, or hydroxyl group.

5. The composition of claim 1, wherein the low profile lubricant and the compound have a ratio between approximately 10:1 and 1:10.

6. The composition of claim 5, wherein the low profile lubricant and the compound have a ratio between approximately 3:1 and 1:3.

7. The composition of claim 6, wherein the low profile lubricant and the compound have a ratio of approximately 1:1.

8. A device comprising:
a magnetic disk; and
a composition on the magnetic disk, the composition comprising a mixture of a low profile lubricant and a compound comprising one or more cyclophosphazene rings, wherein the low profile lubricant comprises a backbone having a perfluoropolyether chain and at least three functional groups attached to the backbone.

9. The device of claim 8, wherein the low profile lubricant comprises at least one functional group on each end of the backbone and a plurality of functional groups located in a region between the ends of the backbone.

10. The device of claim 8, wherein the functional groups comprises hydroxyl groups or diols.

11. The device of claim 8, wherein the one or more cyclophosphazene rings comprise alkoxy or aryloxy substituents.

12. The device of claim 11, wherein the one or more cyclophosphazene rings comprise hydroxyl at least one group.

13. The device of claim 8, wherein the mixture has a thickness of approximately 3 to 25 Å.

14. The device of claim 13, wherein the mixture has a thickness of approximately 9 to 15 Å.

15. The device of claim 8, wherein the low profile lubricant has a molecular weight between 1000 and 30,000 Daltons.

16. The device of claim 8, wherein the low profile lubricant and the compound have a ratio between approximately 10:1 and 1:10.

17. The device of claim 16, wherein the low profile lubricant and the compound have a ratio between approximately 3:1 and 1:3.

18. The device of claim 17, wherein the low profile lubricant and the compound have a ratio of approximately 1:1.

19. The composition of claim 1, wherein the low profile lubricant has one or more cyclophosphazene rings.

20. The device of claim 8, wherein the low profile lubricant has one or more cyclophosphazene rings.
